(19) United States
(12) Patent Application Publication
(10) Pub. No.: US 2016/0194764 A1
(43) Pub. Date: Jul. 7, 2016

(54) FAST AND ECONOMICAL METHODS ANDAPPARATUSFOR MANUFACTURING GLASS LINED METAL OBJECTS BY INDUCTIONHEATING

(71) Applicant: Gordhanbhai Patel, Somerset, NJ (US)

(72) Inventor: Gordhanbhai Patel, Somerset, NJ (US)

(21) Appl. No.: 14/908,104

(22) PCT Filed: Jul. 10, 2014
(86) PCT No.: PCT/US14/46157

§ 371 Date: Jan. 27, 2016

Related U.S. Application Data
(60) Provisional application No. 61/856,327, filed on Jul. 19, 2013.

(51) Int. Cl. C23D 5/04; B08B 7/00; C23D 1/00

(52) U.S. Cl. CPC C23D 5/04; C23D 1/00; B08B 7/0071

(57) ABSTRACT

A metal object coated with a fit of glass or ceramic or a powder of a polymeric material is heated with an induction heater under controlled conditions. Only metal is selectively heated with the induction heating. When metal reaches a desired temperature, the coating melts. This process is significantly faster, less expensive and convenient.

This application claims the benefit of U.S. Provisional Application No. 61/856,327, filed Jul. 19, 2013.

The present invention relates to apparatus and processes for producing glass, ceramic or plastic lined metal objects such as reaction vessels, stirrers and pipes by selectively heating a metal object to melt a coating of glass or ceramic frit or a plastic powder.

### BACKGROUND OF THE INVENTION

Glass is an amorphous solid material. The most familiar type of glass, used for centuries is soda-lime glass typically composed of about 75% silica (SiO₂) plus sodium oxide (Na₂O), calcium oxide (CaO) and several additives. Fused quartz (primarily composed of SiO₂), used for some special applications, has high glass transition temperature of over 1200° C. Normally, other substances are added to simplify processing. One is sodium carbonate (Na₂CO₃, “soda”), which lowers the glass transition temperature. Lime (CaO), magnesium oxide (MgO) and alumina (Al₂O₃ are added to provide a better chemical durability. The resulting glass contains about 70 to 74% silica by weight and is called a soda lime glass. Many other additives are added for special applications. Examples of some common types of silicate glasses are: (1) Fused silica glass is typically composed of silica (SiO₂) which has very low thermal expansion, is very hard and resists high temperatures (1000-1500° C.). It is also the most resistant against weathering. It is used for high temperature applications, such as furnace tubes and melting. (2) Soda-lime-silica glass is typically composed of silica 72%+sodium oxide (Na₂O) 14%+magnesia (MgO) 2-3%+lime (CaO) 10%+alumina (Al₂O₃) 0.5-1.0%. It is transparent, easily formed and most suitable for window glass. It has a high thermal expansion and poor resistance to heat. (3) Sodium borosilicate glass, Pyrex® is typically composed of silica 81%+boric oxide (B₂O₃) 12%+sodium oxide (Na₂O) 4.5%+alumina (Al₂O₃) 2.0%. Pyrex stands heat expansion much better than window glass and used for chemical glassware, cooking glass and car head lamps. (4) Lead-oxide glass, crystal glass is typically composed of silica (SiO₂) 59%+sodium oxide (Na₂O) 2.0%+lead oxide (PbO) 25%+potassium oxide (K₂O) 12%+alumina (Al₂O₃) 0.4%+zinc oxide (ZnO) 1.5%. It has a high refractive index, making the look of glassware more brilliant. (5) Aluminosilicate glass is typically composed of silica (SiO₂) 57%+alumina (Al₂O₃) 16%+boric oxide (B₂O₃) 4.0%+barium oxide (BaO) 6.0%+magnesia (MgO) 7.0%+lime (CaO) 10%. It is extensively used for fiberglass, used for making glass-reinforced plastics (e.g., boats and fishing rods). (6) Oxide glass is typically composed of alumina (Al₂O₃) 90%+germanium oxide (GeO₂) 10% and used for extremely clear glass, used for fiber-optic wave guides in communication networks.

A variety of steel compositions are coated with glass, ceramic, glass-ceramic and plastic. For example, carbon steel (normally used in the chemical industry in general), austenitic stainless steel (can be used at very low temperatures, as low as −120° C.) and duplex stainless steel (ferritic-austenitic steel). Glass-lined equipment constructed of duplex steel has a stainless outside surface that can be polished to a mirror finish, as required by the pharmaceutical industry both for aesthetic reasons and for sterilization requirements.

Glasses, ceramics and glass-ceramics are used in both culinary and tableware applications. In some instances, the base materials have been used in the plain state for such applications, i.e., with no external decoration. Most consumers, however, desire a decorative appearance or finish on such articles which are achieved with glazes and enamels. Practically speaking, glazes are clear glasses and enamels are glazes to which pigments are added to provide color thereto. Both are applied to the surface of the ware to be coated in very finely-divided form (“frit”) and then fired to form a strongly-adherent, continuous film on the ware.

Glass-lined vessels and other chemical processing equipment have found widespread use in numerous industries, particularly in those industries which require the storage or reaction of chemicals or pharmaceuticals. Such equipment finds use, for instance, in reaction, extraction, suspension and distillation processes to name but a few. The linings permit the use of such equipment under various adverse temperature and corrosive conditions. Glass-lined steel equipment is used in a wide range of chemical processes that involve harsh chemicals, including the production of pharmaceuticals, specialty chemicals, agricultural products and polymers. One of the reasons that glass lined equipment is attractive to use is that glass is resistant to attack from most chemicals and to mixtures of corrosive materials. In addition, it has a smooth, anti-stick surface, is easy to clean, and does not introduce impurities to the process materials.

Equipment that is often supplied with a glass lining includes reactors, storage tanks, columns, dryers and filters, as well as pipes, valves and fittings. The internal components of the vessels, such as agitators, baffles and dip pipes, are also supplied with glass coatings. In general, glass-lined vessels are designed to operate at temperatures up to ˜250° C. and pressures of 9-11 kg/cm², although they can be built to withstand much higher temperatures and pressures.

The glasses used for coating metal reactor vessels are of high quality glasses of complex compositions. They may be defined chemically as alkaline borosilicates and are produced by submitting the raw material to a melting process at a high temperature, typically above 600° C. Their main feature is an extremely high degree of chemical inertness with respect to practically all organic or inorganic substances. This property is maintained without distinction over a very wide range of temperatures and in contact with both oxidizing and reducing compounds, chlorinated or not, the only exceptions being hydrofluoric acid (HF) and concentrated alkaline solutions at high temperatures.

Since the glass or coating has an amorphous structure and is a dielectric, it is neither subject to ageing nor to electrochemical or localized corrosion. The extremely hard, smooth, non-porous surface adds further valuable and advantageous qualities to glass-lined equipment such as resistance to wear, non-stick properties, the prevention of the formation of micro-flora, ease of cleaning and sterilization and impermeability to gases. These latter features are of particular value in the pharmaceutical and foodstuffs industries since they are a prerequisite for the purity of the product as well as the durability and immutability of such properties as its color, smell, taste etc.

Glass-lined steel items, such as glass-lined vessels are composite materials consisting of a coating of glass firmly bonded to the base or support of metal such as steel. The molten glass must be capable of wetting the metal, in order to form a strong bond. The thermal expansion of the glass and metal must also be closely matched. The bond between metal and glass is obtained by coating the steel surface with a first lining of special glass, the “ground coat” or primer, the sole basic function is to develop a good union between the glass layer and the metal support. Nickel can bond with glass either as a metal or via the nickel (II) oxide layer. Presence of cobalt in the glass leads to a chemical reaction between the metallic iron and cobalt oxide. Number 304 stainless steel forms bonds with glass. Strong bonding between steel and glass is established during a firing process at a temperature of about 900° C. and is the result of a complex series of electrochemical reactions resulting from the action of binding oxides like CoO and NiO. The strength of this bond is even higher than that of the bonds existing within the glass itself. After this initial phase, the glass-lining cycle provides for the application and firing of additional covering layers (usually three or four) of glass, with the aim of providing the lining or coating with their specific and well-known properties and characteristics.

The glass for the glass-lined vessels is composed of several oxides and silicates. It is blended and heated to the melting point, emptied through a chute, quickly cooled and solidified into particles called frit. The first coat of glass applied to the steel is the ground coat; it has limited corrosion resistance and is used solely to develop a chemical bond with the base metal. After the ground coat is applied, the chemically resistant glass is applied. This procedure is repeated until a desired glass thickness is achieved, which is usually 200-5,000 microns.

Glass-lined objects could get damaged during their use. The leading cause in case of operation of glass-lined equipment is mechanical damage resulting from impact and thermal shock caused by heating or cooling a vessel too quickly. Such damage needs to be repaired. Areas of a glass-lined steel tank to be repaired are heated to ˜800° C. in order to perform repairs of cracks and chips. The glass frit must reflow and fill the damaged areas. Temperature control is crucial due to the flow characteristics of glass. Crazing and cracking can result if heating and cooling occur too quickly or too slowly.

The customary procedure for lining vessels, etc. with thick vitreous coatings of ˜1,000 microns or more usually involves a multiplicity of manufacturing steps, starting with the application of an initial ground coat to the vessel which is dried and then fired. In some instances, a second ground coat is applied and it too must be dried and then separately fired. Multiple cover coats, often five or more are than applied over the ground coat, each requiring independent drying and firing steps. Such coatings are applied by spraying or spraying followed by powder application or by powder application alone.

In the foregoing processes for making thick (˜1,000 microns) vitreous linings, multiple intermediate firing steps are required resulting in noneconomic, low production efficiency manufacturing. Hence, there is a need to develop alternative processes wherein thick cover coats can be applied in fewer steps, preferably in one step. There is also a need for an improved, more economic method for making corrosion resistant, thick vitreous linings free of defects, which can be prepared without multiple intermediate heating steps.

A glass lining is a form of porcelain enamel, much like the material that has been applied to tubs and sinks for many years. It is a combination of glass, water and clay applied to the base metal substrate at high temperature, typically in excess of 700° C. The glass is a combination of different types of borosilicate glass which is ground in a ball mill to a fine powder, approximately the consistency of flour or powdered sugar, which is sifted through 200 mesh screen. It is then mixed with water and a small amount of clay which acts as a binder. Very small amounts of other inorganic materials are added to control the viscosity and flow characteristics of the glass formulation. The water is simply a vehicle used to transport the glass material onto the surface of the pipe or fittings which have been properly prepared by blasting. The glass mixture (often called slip) is sprayed onto the interior surface of the pipe or fittings with special spray lances. Then the pipe or fittings are placed in drying ovens at a temperature of approximately 50-60° C. where the moisture is removed. Once dry, the pipe and fittings are placed into specially designed furnaces and “fired” at approximately 750° C. The firing time will vary slightly, depending on the size and thickness of the iron and whether the base coat or cover coat is being applied. Firing times are typically in the vicinity of 1-2 hours for each of the coatings.

U.S. Pat. No. 4,224,074 discloses production of frits useful in decorating glazes and enamels for glass, glass-ceramic, and ceramic food service ware which exhibit coefficients of thermal expansion (20° C.-300° C.) between about 50-110×10⁻⁷/° C., a viscosity suitable for firing at about 650° C.-775° C., good glass stability, high gloss and excellent resistance to attack by acids and bases, especially detergents such as are used in commercial dishwashers. The frits typically consist of: SiO₂:29-55%, B₂O₃:7-31%, Al₂O₃:2-8%, ZrO₂:5-16%, Na₂O₄:20%, Li₂O:0-7%, Na₂O+Li₂O:6-24% and F:0.75-4% by wt.

It has generally been known that glass can be made alkali-resistant by incorporating zirconium oxide (ZrO₂) in a glass batch and by increasing the content of ZrO₂ in the glass batch, the alkali resistance of the resulting glass increases. For example, Japanese Patent Publication No. 40126/74 discloses a glass composition for the production of alkali-resistant glass fibers, which comprises, by mole %, 62 to 72% of SiO₂, 7 to 11% of ZrO₂, 13 to 23% of R₂O, 1 to 10% of R′O, 0 to 4% of Al₂O₃, 0 to 6% of B₂O₃, 0 to 5% of Fe₂O₃, 0 to 2% of CaF₂ and 0 to 4% of TiO₂, in which R₀O represents sodium oxide up to 2 mole % of which is replaceable by lithium oxide, and R′O represents an alkaline earth metal oxide selected from calcium oxide (CaO), zinc oxide (ZnO) and manganese oxide (MnO). U.S. Pat. No. 4,243,421 discloses an alkali-resistant glass composition additionally consisting essentially of CaO and BaO being 5 to 15% based on the weight of the glass composition and the mole ratio of BaO/(CaO+BaO) being from 0.2 to 0.8%.

Lead-free zinc borosilicate glass compositions are known and have been used as colored frits for bonding to both metal and ceramic substrates. U.S. Pat. No. 4,359,536 discloses a lead-free frit glass exhibiting transparency and gloss with an average thermal coefficient of expansion between 0°-300° C. in the range 75°-90×10⁻⁷/° C. consisting essentially of (in weight percent on the oxide basis): 25-31 ZnO, 12-20 SiO₂, 19-35 B₂O₃, 1-4 Al₂O₃, 5-10 Na₂O, 7-9 CaO, 2-6 BaO, 0.5-4 ZrO₂, 1-2 F and 0-6 K₂O except for incidental impurities and refining agents. U.S. Pat. No. 3,005,722 discloses such a glass composition for use in ceramic type electroluminescent lamp devices wherein the uncolored frit serves as a binder of phosphor particles when fused to a porcelainized iron plate. Colored enamels using said type glass compositions are also disclosed in U.S. Pat. No. 3,527,649 which can employ various inorganic pigments such as cadmium, selenium, iron, copper, cobalt and other metal compounds to produce highly colored glazes when fired on ceramic ware. A known zinc borosilicate frit glass for adherence to the soda-lime glass bulb surface of an incandescent lamp has a typical composition in weight percent as follows: ZnO-28.3, SiO₂-19.4, B₂O₃-21.7, Al₂O₃-2.7, Na₂O-4.9, K₂O-6.1, CaO-4.3, BaO-3.7, TiO₂-4.5, F-2.8 and Sb₂O₃-1.6. This glass composition exhibits a linear thermal coefficient of expansion in the 0°-300° C. temperature range of approximately 70-80×10⁻⁷/° C. in order to accommodate the thermal expansion characteristic of the soda-lime glass when bonded thereto during the firing at elevated temperatures.

U.S. Pat. No. 4,537,862 discloses a glass frit compositions that are lead-free, cadmium-free and zinc-free. The compositions having improved chemical resistance, especially acid resistance (acetic acid) of a loss of generally less than about 1.9% by weight. The compositions contain B₂O₃, SiO₂, ZrO₂ and rare earth oxides, the weight ratio of ZrO₂ to rare earth oxides being critical and being about 1/1 to 1.4/1.

U.S. Pat. No. 4,361,654 discloses a non-fluorine porcelain enamel frit for sheet iron ground coat is disclosed, which contains neither fluorine nor fluorine compound, but has excellent firing property and can be worked into sheet iron enamel having high gloss and adherence and low surface roughness. The frit consists of 100 parts of a main component and 7-42 parts of an auxiliary component, said main component consisting of 30-73 parts of SiO₂ or a mixture of SiO₂ and at least one of TiO₂, ZrO₂ and SnO₂, 8-45 parts of B₂O₃, and 8-41 parts of Na₂O or a mixture of Na₂O and at least one of Li₂O and K₂O, and said auxiliary component consisting of not more than 12 parts of Al₂O₃, 1-22 parts of at least one of CaO, BaO, ZnO, MgO and SrO, from more than 0 part to 7 parts of MoO₃ or a mixture of MoO₃ and at least one of V₂O₅, P₂O₅ and Sb₂O₃, and 0.5-10 parts of at least one of CoO, NiO, CuO, MnO₂ and Fe₂O₃.

U.S. Pat. No. 4,731,347 discloses a glass frit comprising about 60% by weight of glass formers, 30% by weight of monovalent fluxes and 10% by weight of divalent fluxes; the glass formers consisting essentially of SiO₂ and B₂O₃; the monovalent fluxes consisting essentially of Li₂O, Na₂O and K₂O; the divalent fluxes being selected from the group consisting of CaO, SrO, BaO and PbO; and trace elements not exceeding 10% by weight. The glass has a coefficient of thermal expansion of 7.2×10⁻⁶/° F./13×10⁻⁶/° C. over the range from room temperature to 310° C. It is useable to make a slip where it can be fired at temperatures around 510° C. and applied to a suitable substrate in accordance with existing practices to provide a high quality coating or a viscous damper. Suitable substrates include many nickel-base alloys and stainless steels.

U.S. Pat. No. 4,892,847 discloses lead-free glass frit compositions for use in vitreous coatings consisting essentially of SiO₂-Bi₂O₃-B₂O₃-alkali metal oxide-ZrO₂/TiO₂ in appropriate concentrations.

U.S. Pat. No. 4,975,391 provides an enamel frit composition which comprises a component selected from the group consisting of SiO₂, B₂O₃, Al₂O₃, CaO, MgO, Na₂O, K₂O, Li₂O, BaO, ZnO, TiO₂ and ZrO₂, and one or more lanthanoid elements of the atomic numbers of 58 to 60 and 62 to 71 and which enables direct coating without any ground coating.

U.S. Pat. No. 5,281,560 discloses lead-free, tin phosphate glasses containing 25-50 mole percent P₂O₅, 30-70% SnO, 0-15% ZnO, the mole ratio of SnO:ZnO being greater than 5:1, and an effective amount up to 25% total of at least one oxide in the indicated proportion selected from the group consisting of up to 25% R₂O, wherein R₂O consists of 0-25% Li₂O, 0-25% Na₂O, and 0-25% K₂O, up to 20% B₂O₃, up to 5% Al₂O₃, up to 5% SiO₂, and up to 5% WO₃. The glasses are particularly useful as sealing glass frits in sealing material to join component parts in electrical and electronic devices. The sealing glass material may contain mill additions to reduce the effective coefficient of thermal expansion in a seal, as well as a strength reinforcing additive having a coefficient of thermal expansion preferably below 120×10⁻⁷/° C.

U.S. Pat. No. 6,100,209 discloses a glass frit which is prepared by heating an initial glass frit in the presence of a reducing agent so as to reduce metal moiety in the glass structure of the frit and then cooling the reaction mixture. Preferably, the frit prepared is used in a method of forming electrically conducting silver tracks on enamel on glass windows, by applying to window glass an enamel composition containing the frit and on top thereof a silver composition in the shape of the tracks and firing the compositions, such that on the firing the reduced metal moiety reduces silver ions migrating through the enamel composition from the silver composition to elemental silver and thereby prevents or impairs them from interacting with the glass to form visible tracks.

U.S. Pat. No. 8,278,229 provides a cover coating composition for a glass lining comprising a frit constituting the composition which mainly includes 65 to 75 mol % of SiO₂, 2 to 8 mol % of ZrO₂, 10 to 22 mol % of R₂O where R represents Li, K, or Cs, and 2 to 12 mol % of R′O where R′ represents Mg, Ca, Sr, or Ba, and the frit is free of Na₂O, and said cover coating composition for a glass lining may further contain a metal fiber.

Various methods and apparatus have been proposed to apply internal coatings to tubular articles, such as reactors. Typical examples of these are: U.S. Pat. Nos. 3,351,289; 3,484,266; 3,827,633; 3,876,190, and 4,150,176. Generally booms or lances, consisting of an elongated tubular member are utilized. Coating material is fed in one end, transported through the tube portion, to and through, a distribution means located in the end of the boom positioned within the article being coated. As the boom moves through the length of the article, the interior of the article is coated.

The most widely used method of applying a vitreous coating to the interior of an article involves the room temperature surface application of particulate vitreous material in a carrier, such as water. This is usually done by spray coating. After the mixture is applied, the article is dried to remove the carrier and subsequently fired. This process is repeated several times to obtain the desired coating thickness. Most processes, such as those disclosed in U.S. Pat. No. 3,484,266 and other listed herein initially distribute particulate materials on the vessel surface and subsequently in a separate step fuse the particles to obtain the finished coating. The reason a subsequent, and separate, firing step is required, is that mechanical apparatus, such as mechanisms to feed and distribute particulate glass, do not reliably operate at glass firing temperatures. Typically, such temperatures range between about 820° C. and about 1010° C. At such temperatures, the particulate feed material frequently becomes tacky and difficult to feed or distribute. The result frequently is an uneven or otherwise defective coating.

U.S. Pat. No. 4,532,885 provides an apparatus for distributing a stream of solidifiable, finely divided, vitreous coating material onto a heated internal surface of a concave article, such as a tank or a reaction vessel, to form a smooth, uniform, continuous, fused coating thereon. The apparatus consists of a horizontally mounted disc rotor which has a plurality of radially directed vanes mounted thereon. The vanes extend short of the rotor center defining a central chamber. The central chamber contains a tubular particle directing cage. The cage has a hollow central impeller, coaxially aligned, and spacedly positioned therein. The impeller is connected with the rotor by a common rotatable shaft. A supply of finely divided vitreous material is fed into the hollow of the impeller and directed through openings in the impeller into the cage member. The rotation of the impeller within the cage member extrudes a metered supply of the feed material through a discharge opening in the cage member into the vane area and rotation of the vanes centrifugally distributes the feed material in an outward direction toward the surface to be coated.

U.S. Pat. No. 5,387,439 discloses a process for preparing a chemically resistant coating in which a substrate is sequentially contacted with a ground coat, fired, contacted with an intermediate coat, fired, and contacted with a cover coat and fired. The intermediate coat is comprised of a minor amount of inorganic fiber which has a softening point in excess of 950° C., an average length of from about 100 to about 750 microns, an average diameter of from about 515 microns, and an average aspect ratio of from about 10:1 to about 75:1.

European Patent Application EP1354978 discloses a glass-lining application method which enables stable, uniform glass lining layers to be applied to large glass-lined instruments composed of a stainless base material, the method including forming a thermal spray treatment layer by applying a thermal spray treatment to a surface of a stainless base material using a thermal spray material selected from a group composed of a stainless material identical to the base material, Ni metal, Cr metal, Fe metal, Co metal, Ni—Cr alloys, and Fe—Cr alloys, then forming a glass lining layer on the thermal spray treatment layer by means of a glass lining heat treatment using a ground coat and a cover coat, a surface roughness of the thermal spray treatment layer being within a range from 5 to 100 microns and an open pore diameter being within a range from 3 to 60 microns.

EP 0221687 discloses uniform, corrosion resistant vitreous linings for lining equipment and accessories used in processing and manufacturing chemicals and pharmaceuticals have thicknesses in the range of about 800 to 2,000 microns and are applied by electrodeposition methods without multiple intermediate firing steps.

Induction heating is the process of heating an electrically conducting object (usually a metal) by electromagnetic induction, where eddy current (also called Foucault currents) are generated within the metal and resistance leads to Joule heating of the metal (Valery Rudnev, Handbook of Induction Heating, CRC Press, 2003 ISBN 0824708482). An induction heater consists of an electromagnet through which a high-frequency alternating current (AC) is passed. Heat may also be generated by magnetic hysteresis losses in materials that have significant relative permeability. The frequency of AC used depends on the object size, material type, coupling (between the work coil and the object to be heated) and the penetration depth.

Induction heating allows the targeted heating of an applicable item for applications including surface hardening, melting, brazing and soldering. Iron and its alloys respond best to induction heating, due to their ferromagnetic nature. Metals that can be melted include iron/steel, copper, aluminum and precious metals. Because it is a clean and non-contact process it can be used in a vacuum or inert atmosphere. Vacuum furnaces make use of induction heating for the production of specialty steels and other alloys that would oxidize if heated in the presence of air.

Induction heating is often used in heat treatment of metal items. The most common applications are induction hardening of steel parts, induction soldering/brazing as a means of joining metal components and induction annealing to selectively soften an area of a steel part.

Induction heating can produce high power densities which allow short interaction times to reach the required temperature. This gives tight control of the heating pattern with the pattern following the applied magnetic field quite closely and allows reduced thermal distortion and damage.

The basic setup is an AC power supply that provides electricity with low voltage but very high current and high frequency. A workpiece to be heated is placed inside an air coil driven by the power supply, usually in combination with a resonant tank capacitor to increase the reactive power. The alternating magnetic field induces eddy current in the workpiece. Typical frequency used varies from 5-1,000 kHz. Thicker materials require lower frequency. The induction coil is usually made of copper tubing which is fluid cooled. Diameter, shape, and number of turns influence the efficiency and field pattern.

The methods and apparatus currently used and reported in the literature for lining metal objects with glass, ceramic and plastics are still convection heating in a furnace. Typically, the coated parts are heated in a furnace, usually in an electric furnace. This method requires heating whole object for a long time and requires lots of energy. These several decades old systems are very inefficient, expensive and slow. Though induction heating of metal parts is known, there is no report on heating metal objects coated with glass for coating with glass, ceramic, glass-ceramic or plastic.

### BRIEF SUMMARY OF THE INVENTION

It is an object of this invention to develop fast, safe, convenient and economical methods and apparatus for manufacturing ceramic, glass and plastic layered metal objects by induction heating. The layers may be on an inside surface or an outer surface of the metal object,

A main objective is to glass-line a metal object by melting coated glass by induction heating. In a preferred embodiment, the metal object is a steel or iron object, for example, a steel tubular vessel.

Another objective relates to a glass-lined or coated utensil wherein the coating is obtained by melting coated glass with induction heating.

The main objective is the repair of glass layered metal objects by applying and melting the glass by induction heating. One embodiment relates to the repair glass lined metal objects by applying and melting the glass by induction and convection heat generated by induction heating.

Provided also is a process of heating a metal object coated with a glass composition with an induction heating to melt the glass coating composition.

Another main embodiment relates to a process of heating a metal vessel coated with a ground coat and a glass frit with an induction heating coil to melt the coatings to make a glass lined vessel.

The invention also relates to an apparatus which holds a metal object having a coating of glass frit and an induction heating system. One embodiment relates to an apparatus which holds a tubular metal object having a coating of glass frit, an induction heating system and a device to rotate the metal object.

Another object relates to a process of heating a metal object coated with a glass frit with a relatively smaller induction heating coil to melt the coating either by moving the coil or the metal object up or down.

Provided is a system composed of a metal object coated with a glass frit and an induction heating coil. Provided also is a process of melting glass frit coated on a metal object with an induction heating.

Also provided is a process of providing glass frit on a metal object and melting the frit with an induction heating.

Another object of the invention is a process of melting glass frit on a metal object with convection heat from another metal object heated with an induction heating.

Provided is a process of glass lining a metal object wherein molten glass is applied on the metal object heated with an induction heating. The molten glass can be applied for example with a squeegee on the metal object heated with an induction heating.

Thus the invention relates to a process of layering a glasslike coating either inside a metal object or on an outer surface.

More particularly, the invention relates to a method of making a glass layered metal object which comprises placing a ground coating or primer layer on the metal object, placing a glass coat on the ground coating layer, and melting the ground coating layer and the glass coat by induction heating the metal object. Non-limiting examples of a metal object include a steel reaction vessel, other reactors, storage tanks, columns, dryers and filters, pipes, valves, fittings, agitators and baffles,

Another embodiment relates to a method of making ceramic layered steel utensils which comprises placing a ground coating layer on the steel utensils, placing a glass or enamel coat on the ground coating layer, and melting the ground coating layer and the glass or enamel coat by induction heating the steel utensil. Non-limiting examples of utensils include cutlery, and tableware.

In those cases where a primer layer is not required the invention relates to a method of making a glass layered metal object which comprises placing a glass coat on the ground coating layer and melting the glass coat by induction heating the metal object.

Another embodiment relates to placing glass frit on the metal object; and melting the glass frit on the metal object by convection heating from heat generated by another metal object heated with an induction heating. The glass frit may be sprayed on the metal object which is preheated with an induction heating system. In another embodiment, the metal object is not heated until after spraying the frit.

Another embodiment relates to the process wherein the glass coat is a spray coating of a powder of glass, ceramic, glass ceramic, enamel or plastic.

Another embodiment relates to a process of repairing a glass layered metal object comprising applying a coat of glass powder, melting the powder by induction heating the metal and convection heat generated by induction heating of a metal object.

The process may be varied by applying a coat of glass powder to the metal object, and melting the powder by convection heat generated by induction heating of a metal object.

Yet another embodiment of the invention relates to a process of cleaning a glass layered metal object by heating the object with induction heating.

Another embodiment relates to the process wherein molten glass is the glass coat that is applied on the metal object. The molten glass can be applied with a squeegee.

The induction heating system is located outside the metal object or inside the metal object, or there may be induction heating systems both inside and outside the object.

In some occasions the heat that melts the glass coat in a metal object is generated by heating another metal object with induction heating.

The invention also relates to an apparatus for applying a glass layer on a metal object comprising a metal object coated with a ground coat and a cover glass coat, an inducting heating coil for heating the metal object by induction heating the metal and a means to move the metal object up and down the coil. In another embodiment, the metal object remains stationary and the heating system moves up and down the metal object

The invention also relates to a system which combines a physical cleaning system with an induction heating system so that a metal object can be cleaned and repaired without changing systems.

### BRIEF DESCRIPTION OF THE FIGURES

The foregoing and other objects, features and advantages will be apparent from the following description of the preferred embodiments of the invention as illustrated in the accompanying drawings, examples and preferred embodiment. The invention is more fully described below in conjunction with the figures wherein:

FIG. 1 shows a schematic presentation of a rapid surface cleaning system for removing rust from a tubular steel container.

FIG. 2 shows a schematic cross sectional presentation of a rapid surface cleaning system of FIG. 1.

FIG. 3 shows a schematic presentation of an induction heating system for heating whole tubular vessel.

FIG. 4 shows a schematic presentation of an induction heating system for selective partial heating of a moving tubular vessel.

FIG. 5 shows a schematic presentation of an induction heating system for selective partial heating of a tubular vessel with a moving induction heating coil.

FIG. 6 shows a schematic presentation of an induction heating system for irregular shaped objects.

FIG. 7 shows a schematic presentation of an induction heating system with induction coil parallel to the length of the vessel.

FIG. 8 shows a schematic cross sectional presentation of induction heating system of FIG. 7.

FIG. 9 shows a schematic cross sectional presentation of induction heating system of FIG. 7 with another induction coil inside the metal vessel.

FIG. 10 shows a schematic cross sectional presentation of induction heating system of FIG. 7 with another induction coil to heat a coating by convection heating.

FIG. 11 shows a schematic cross sectional presentation of induction heating system similar to that of FIG. 10 but with outside induction heating coil replaced with an insulation.

FIG. 12 shows a schematic cross sectional presentation of partial inner and outer partial induction heating system with rotating metal vessel.

FIG. 13 shows a cross sectional schematic presentation of a glass-lining system by spray coating glass frit inside a metal vessel.

FIG. 14 shows a cross sectional schematic presentation of a glass-lining system by pumping molten glass inside a metal vessel.

FIG. 15 shows a cross sectional schematic presentation of a glass-lining system by squeegeeing molten glass inside a metal vessel.

FIG. 16 shows a schematic cross sectional presentation of an arrangement for repairing a glass lined vessel with induction and convection heating.

### DETAILED DESCRIPTION OF THE INVENTION

The present inventions can best be described by reference to the Figures.

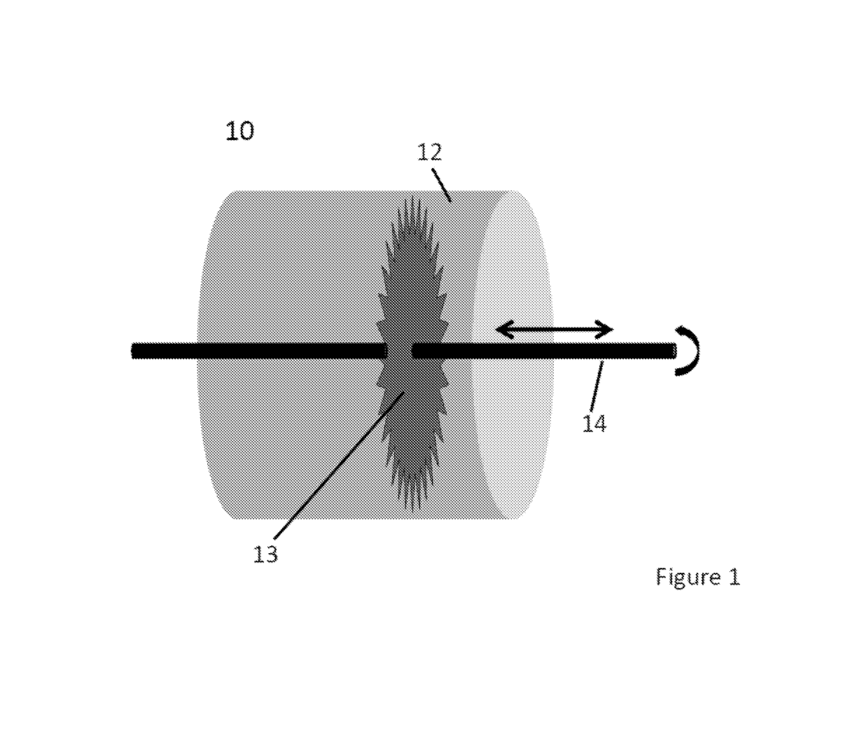

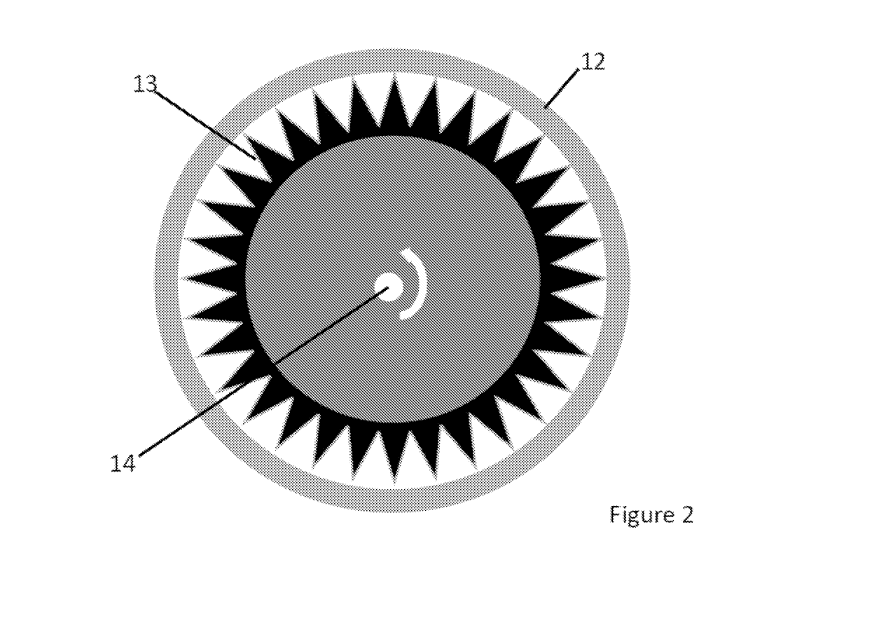

FIG. 1 is a schematic presentation of a rapid cleaning system 10 for removing materials such as rust from a tubular steel vessel 12. FIG. 2 is a schematic cross sectional presentation of a rapid surface cleaning system of FIG. 1. At the tip of the cleaning wheel 13, there can be one or more high pressure water jets, wire brushes, sand blasting nozzles and alike. The cleaning wheel can move in and out by pushing the axel 14 in and out in a controlled manner. The cleaning wheel 13 can also be used for coating rust removing chemical formulations. Fast cleaning is required to minimize the rusting of the surface of vessel made of iron, especially during humid environment. The proposed equipment will be fast, economical and convenient. A cleaning formulation to be used will depend upon many factors such nature and extent of rust and roughness required.

Once the vessel is cleaned, a ground coat can be applied on the cleaned metal surface and heated to melt the ground coat using one of the induction heating apparatus and processes disclosed herein. After melting the ground coat, one can apply a suitable coat of glass frit and heated to melt the glass frit using one of the induction heating apparatus and processes disclosed herein.

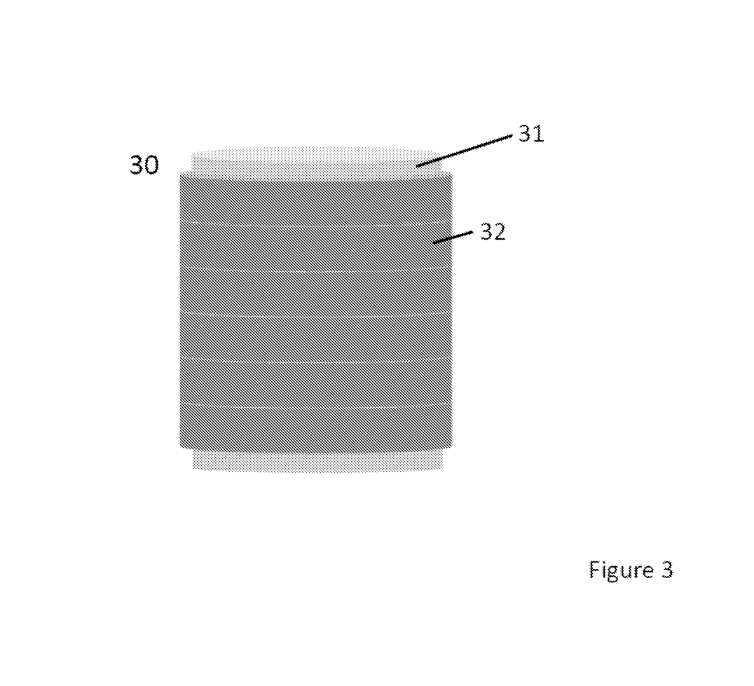

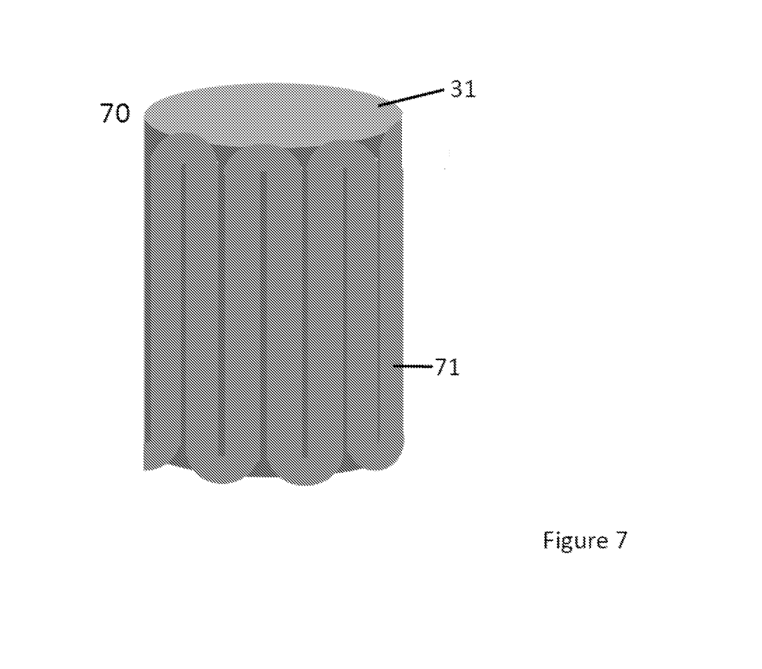

FIG. 3 is a schematic presentation of an induction heating system 30 showing a tubular metal vessel with a fusible coating, such as a glass frit (not shown) on the inside wall of the vessel 31 and an induction heating coil 32 going around the vessel 31. This arrangement provides complete heating of the vessel just like that in a conventional electric furnace. The system 30 shown in FIG. 3 is vertical but it can be at any angle; vertical, horizontal or in between. The induction coil can be inside or one induction coil inside and other outside the vessel. When current is applied, the whole vessel will be heated and the coating will melt when proper temperature is reached. Once the glass coating is melted, the system can be allowed to cool slowly. The rate of heating can be controlled by current/frequency supplied to the induction coil. The induction heating system of FIGS. 3 and 7 will be fast but will required more power.

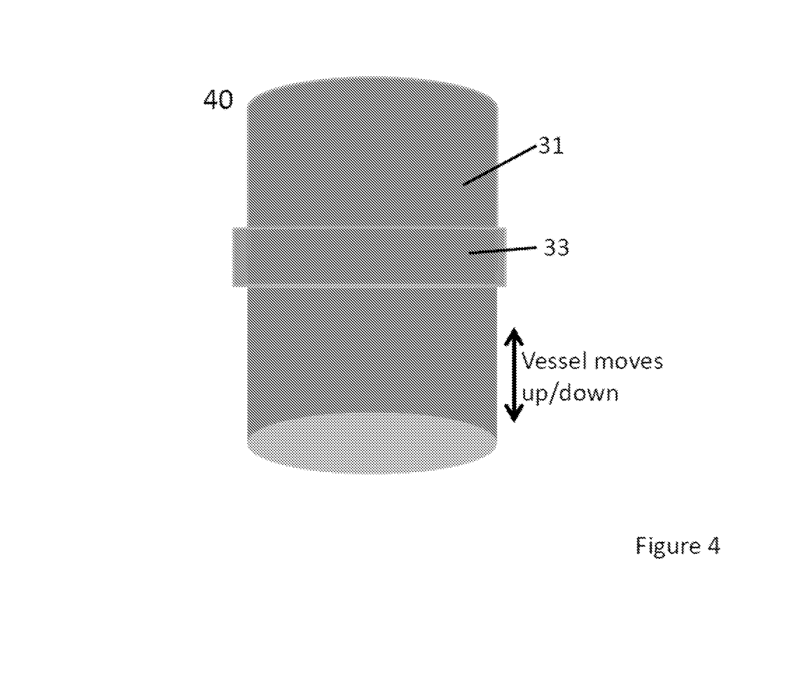

FIG. 4 is a schematic presentation of an induction heating system 40 showing a tubular metal vessel 31 with a fusible coating such as a glass frit (not shown) on the inside wall of the vessel and a stationary induction heating coil 33. The vessel moves up or down at a controlled speed. A narrow stationary induction heating coil 33 goes around the vessel for a partial and selective heating of the vessel 31. There can be another induction coil inside the vessel. This system is more practical for small objects such as metal pipes. The power requirement of this system 40 will be less as the induction coil is smaller compared to that of FIGS. 3 and 7. The metal under the induction coil will get heated and melt the coating. As the vessel moves up or down, the frit will selectively and continuously melt and then solidify/annealed as the vessel moves up or down. This heating system will be slow but will require less power.

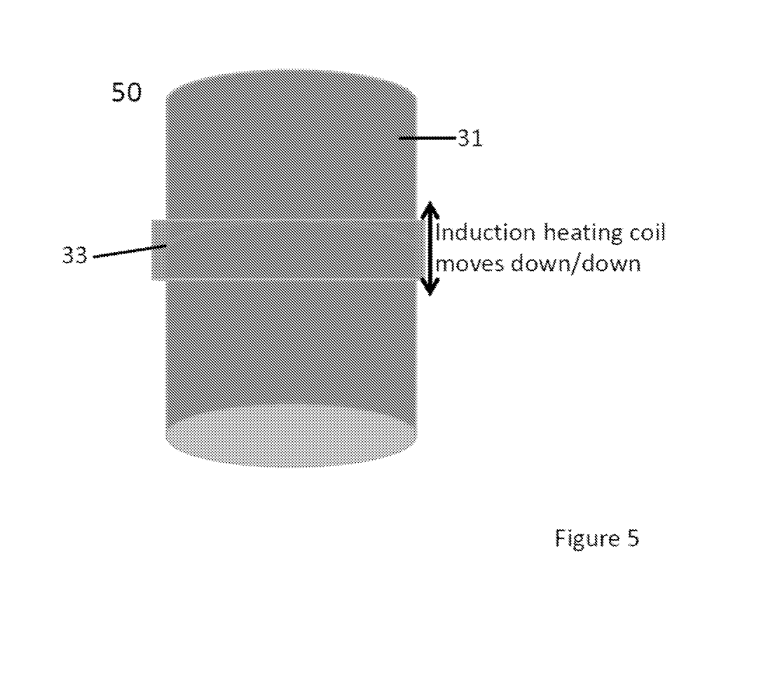

FIG. 5 is a schematic presentation of an induction heating system 50 showing a tubular metal vessel 31 with a fusible coating such as a glass frit on the inside wall of the vessel and a narrow induction heating coil 33 going around vessel for a partial and selective heating of the vessel. The induction coil can be moved up and down. There can be another induction coil inside the vessel. This system is also more practical for large tubular objects as it is easy to move the induction coil rather than a vessel. The power requirement will be less as the induction coil is smaller. The system will heat the metal and melt the frit under the induction coil only. As the induction coil moves up or down, the frit will selectively and continuously melt and then solidify and annealed as the coil moves up or down. This heating system will be slow but will require less power.

The speed of movement of induction coil or vessel will depend upon many factors such as heating capacity of the induction coil, thickness of metal and frit coating, nature and melting point of the frit, heating and cooling/annealing rate required.

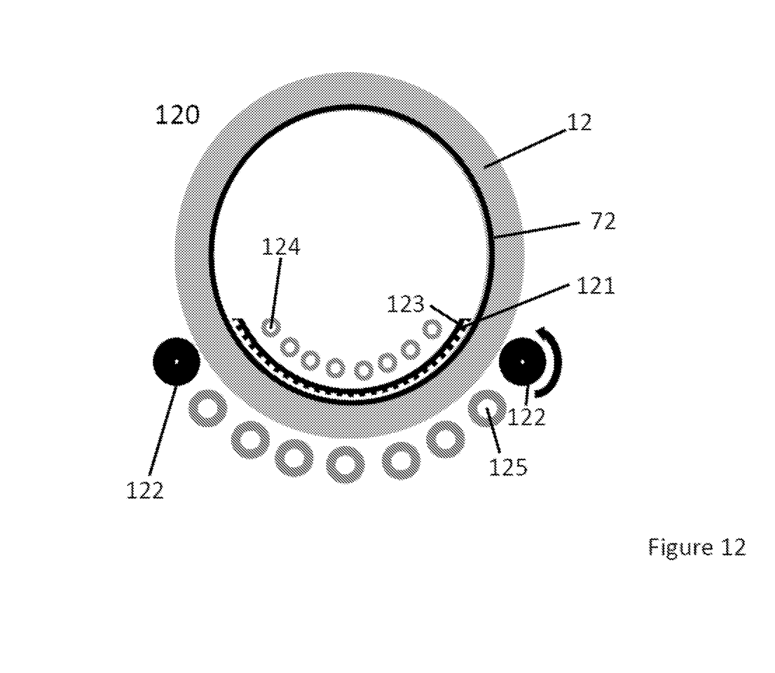

As only a portion of the vessel is heated, it is possible to use higher temperature without deformation of the vessel and for complete melting of ground coat for strong bonding with metal and smooth and defect free coating of the cover coat. It is also possible to melt a nano coat of chemical resistant silica (SiO₂) as nano particles will melt at a lower temperature. This is especially possible when the glass coats are also heated with an extra induction/convection heater shown in FIG. 12.

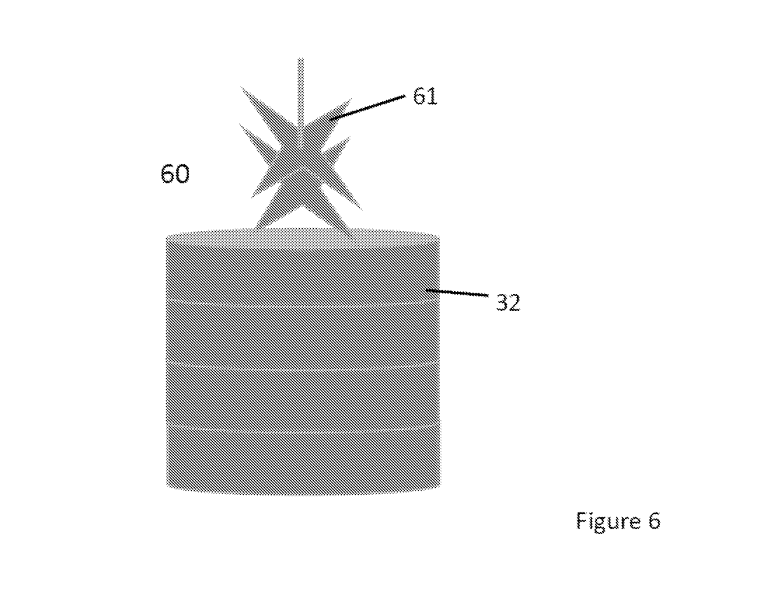

FIG. 6 is a schematic presentation of an induction heating system 60 for irregular shaped objects 61, such as a stirrer, elbow pipe, top and bottom parts of reaction vessel coated with fusible materials. The system can be inside an insulated chamber to prevent heat loss. The induction coil 32 can be configured to match the shape of the object. The irregular shaped object coated with glass frit can also be heated by passing through induction heating coils under controlled conditions.

It is possible to heat irregular shaped parts such as a stirrer, elbow pipe, top and bottom parts of reaction vessel with the induction heating with arrangement similar to that shown in FIG. 6 and spray frit of ground coat followed by that of glass cover coat. The frit will stick to the sufficiently heated part. The part can be heated inside the induction heating system and spray coat with a frit outside before it cools followed by repeating process to smooth the coating. This arrangement is similar to that of electrostatic spray coating of plastic powder or paint. In this case the frit will stick only to the heated part.

FIG. 7 is a schematic presentation of an induction heating system 70 showing a tubular metal vessel 31 with a fusible coating such as a glass frit (not shown) on the inside wall of the vessel and an induction heating coil 71 going around the vessel for complete heating of the frit coated vessel 31. The induction coil is shaped parallel to the length of the vessel. The system shown is vertical but it could be at any angle, vertical, horizontal or in between. The induction coil can be inside or one induction coil inside and the other outside the vessel. The whole vessel will be heated and hence the entire coating will melt at one time. This type of induction coil arrangement is preferred as the induction coil can easily be configured for vessels of different diameters and lengths.

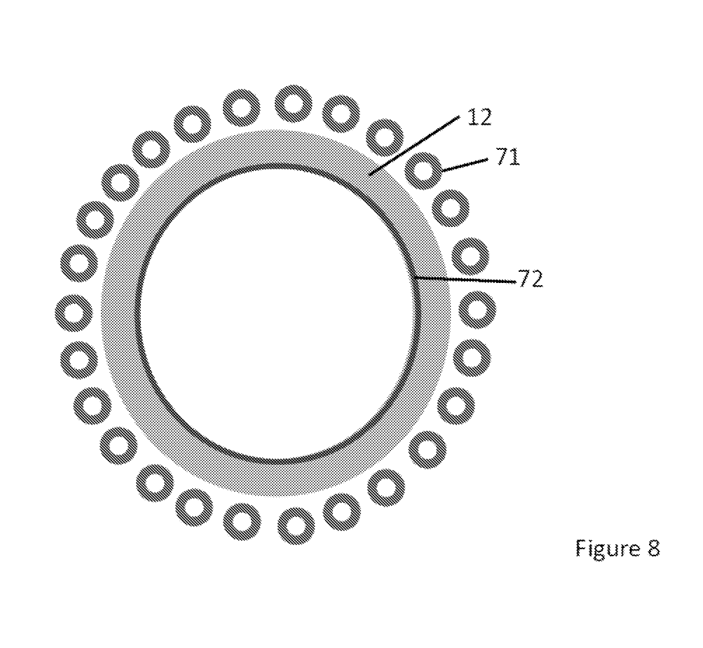

FIG. 8 is a schematic cross sectional view of induction heating system of FIG. 7 showing glass frit 72 on vessel 12.

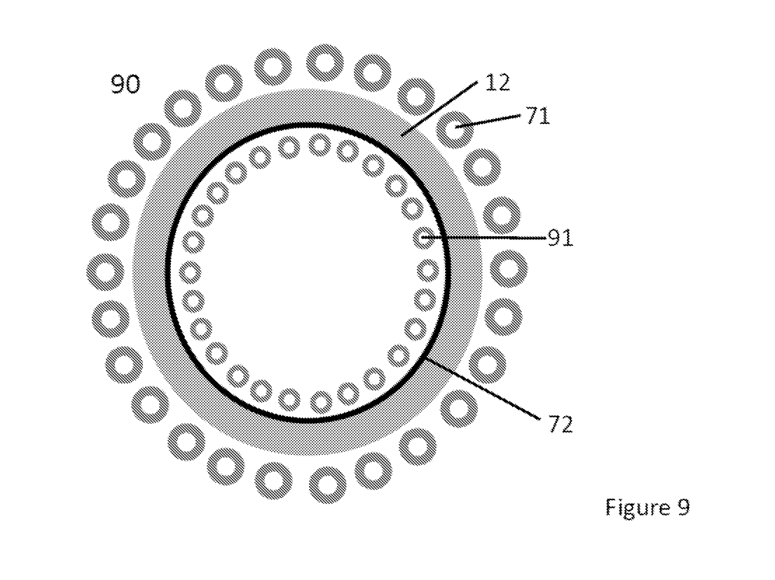

FIG. 9 is a schematic cross sectional view of induction heating system 90 similar to that of FIG. 7 with another induction coil 91 inside the metal vessel. This system will require more power but will heat the vessel faster than that shown in FIGS. 7 and 8.

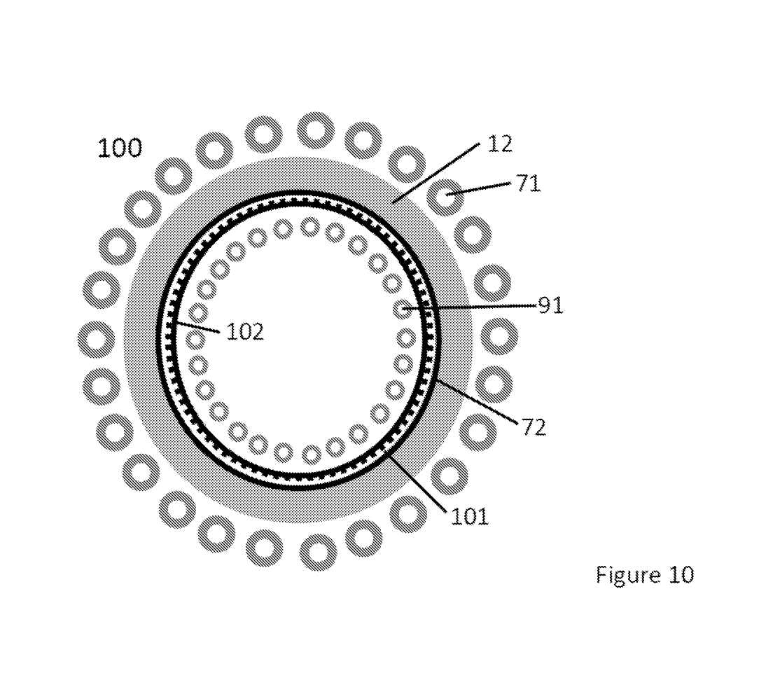

FIG. 10 is a schematic cross sectional presentation of induction heating system 100 similar to that of FIG. 7 with another induction coil 91 inside the metal vessel 12 and a sheet or cylinder of a high melting metal 101 with an insulation 102 for heating the frit 72 by convection heating. If there is a need to heat the glass frit at faster rate and a metal cylinder made from a high melting metal facing the frit 72 can be used as shown in FIG. 10. The high melting metal sheet or cylinder 101 can have insulation 102 to minimize the heat loss. When current is applied to the inner induction coil, it will heat the high melting metal sheet or cylinder 101 as well and the heated sheet will act like an electric heating element which can help in melting the frit or achieve a higher temperature faster. This system provides heating by induction and convection simultaneously.

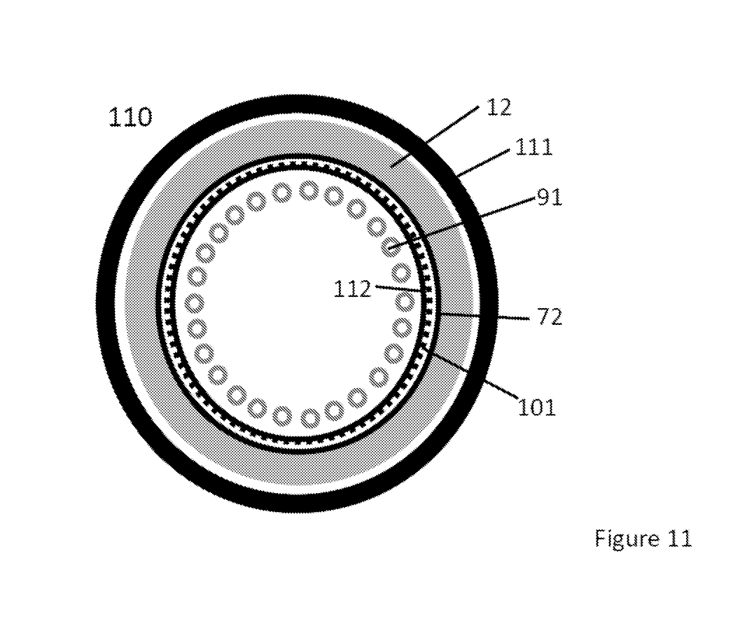

The outer induction coil 71 of the system shown in FIG. 10 can be replaced as shown in system 110 of FIG. 11. The vessel 12 to be glass lined may require an insulation 111 on the outside. When current is applied to the induction coil 91, it will heat the high melting metal sheet and cylinder 101 will act like an electric heating element which can melt the frit 72. This system provides heating by induction and convection. The high melting metal sheet 101 can have insulation 112 to minimize the heat loss.

FIG. 12 is a schematic cross sectional presentation of an induction heating system 120 showing (1) a tubular metal vessel, especially large vessel 12 with a fusible coating 72 such as a glass frit on the inside wall of the vessel, (2) two partial induction heating coils, one inside 124 and the other outside 125 the vessel 12, (3) a high melting metal sheet 121 with an insulation 123 for heating of the frit 72 by convection heating and (4) a set of rollers 122 for rotating the vessel. The rotational speed of the vessel and current applied to induction coils can be controlled for proper melting and annealing of the glass.

If the vessel is standing vertical, there is no need for the rollers 122 and similar system can be used for onsite repair of the glass lined vessels. This kind of arrangement can quickly heat the glass lining and repair the microscopic or thin cracks and pinholes.

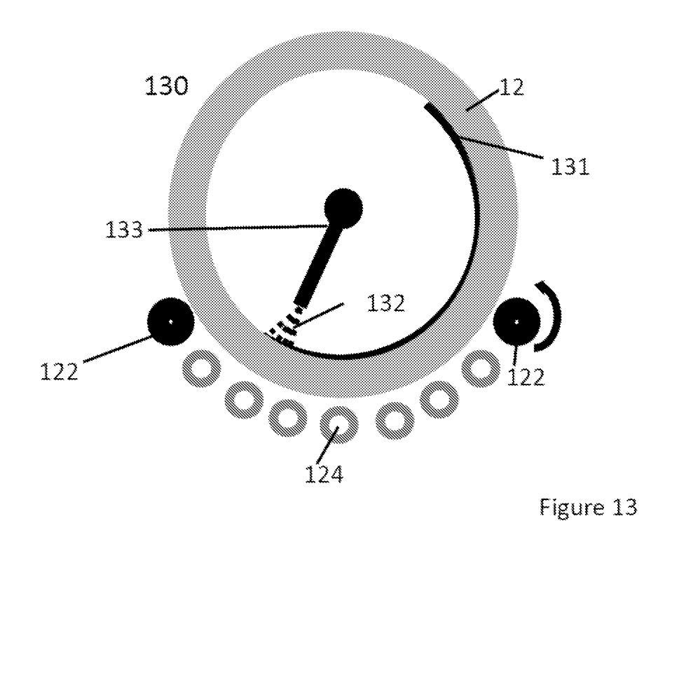

FIG. 13 is a cross sectional schematic presentation of a glass-lining system 130 by spray coating glass frit 132 with a frit sprayer 133 inside a metal vessel 12 pre-heated with an induction heating system 124. The vessel can be rotated on rollers 122. Instead of pre-coating the entire vessel with frit, proper amount of the frit can be applied/sprayed along the length of the vessel 12 as the vessel rotates. As the vessel rotates the portion of the vessel will be sufficiently heated to melt the frit to get glass lining 131. In identical cases, frit can be applied inside the vessel in FIGS. 4 and 5.

If the vessel is standing vertical, there is no need for the rollers 122 and the frit 132 can be just sprayed or blown inside the vessel. The frit will stick only on the sufficiently hot part of the vessel 12. This arrangement will be identical to the electrostatic spray coating of power or paint on electrostatically charged metal parts. In this case, it will be sufficiently heated portion of the vessel.

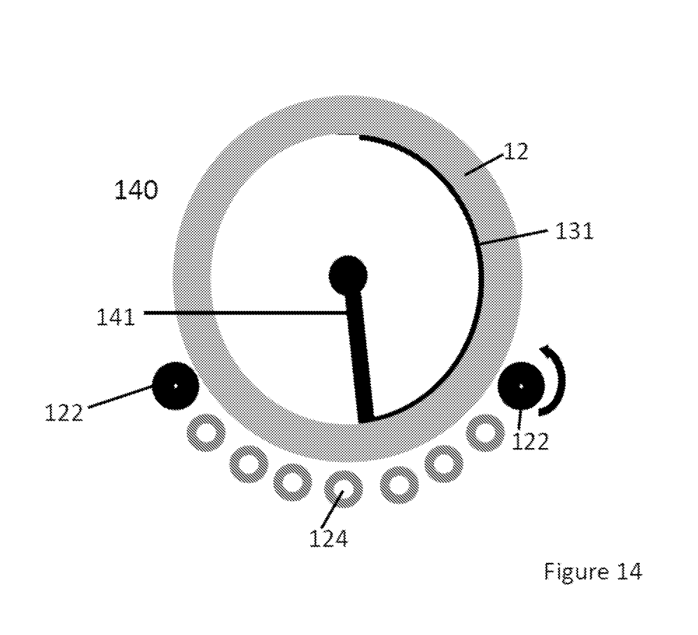

FIG. 14. A cross sectional schematic presentation of a glass-lining system 140 by pumping molten glass with a system 141 inside a metal vessel 12 pre-heated with an induction heating system 124 to get glass lining 131. The system 141 for melting and supplying molten glass to the vessel 12 can be heated with an induction heating coils 124. In identical cases, molten frit/glass can be applied inside the vessel in FIGS. 4 and 5.

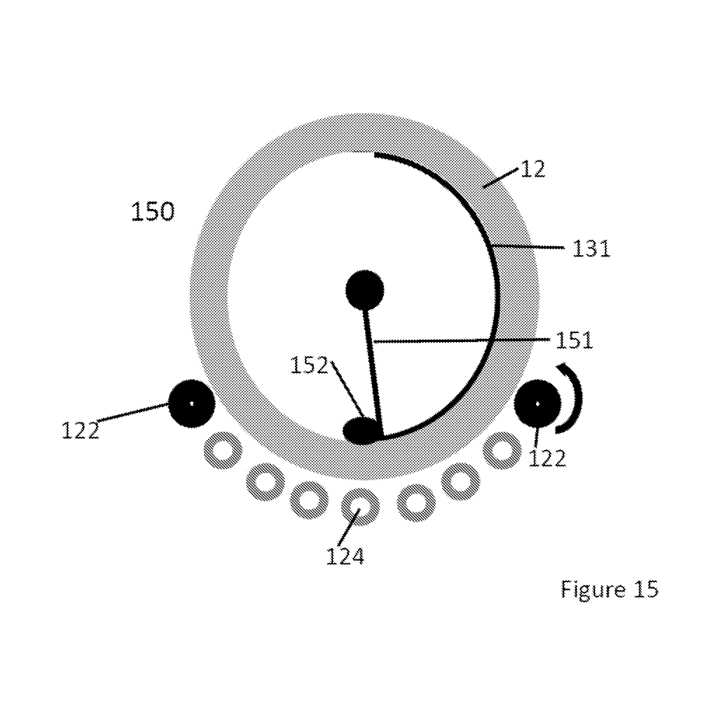

FIG. 15. A cross sectional schematic presentation of a glass-lining system 150 by squeegeeing molten glass 152 with a squeegee 151 inside a metal vessel 12 pre-heated with an induction heating system 124 to get glass lining 131. In identical cases, molten frit/glass can be applied inside the vessel in FIGS. 4 and 5.

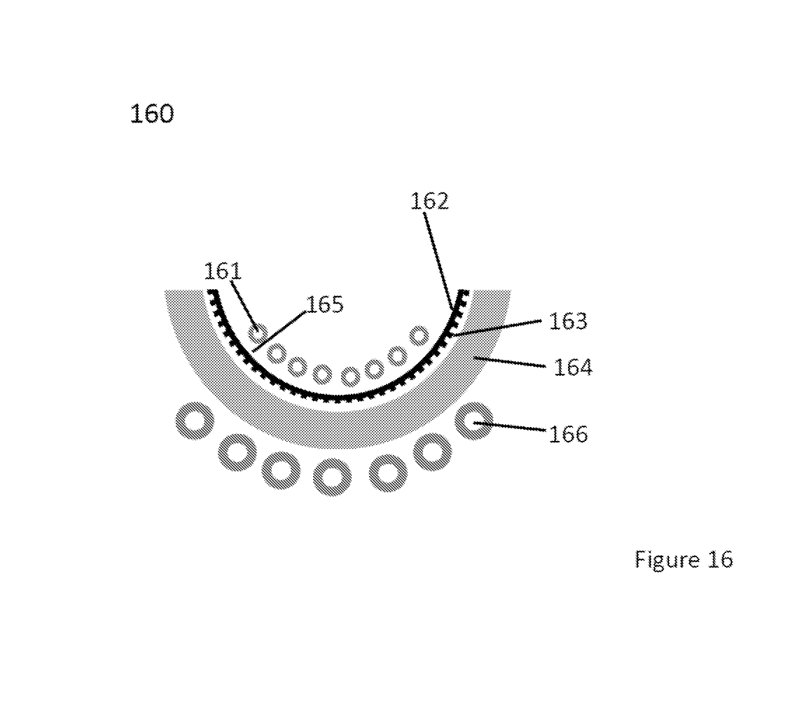

FIG. 16 is a schematic cross sectional presentation of a system 160 for repairing a glass lined vessel with induction and convection heating. An induction heating system 166 can be applied on outside and similarly another induction system 161 can be applied inside a damaged vessel 164 to melt glass frit 163. A high melting metal sheets 162 with an insulation 165 can be used to melt the glass by convection heating. One may need to heat from both the sides or only from one side. The size and shape of this repair arrangement will depend on the parts and defects to be repaired to repair a cracked or damaged part.

The shape and size of the parts shown above can be changed as required. There also can be multiple parts, e.g., two induction heating elements in FIGS. 4 and 5.

A metal object can be glass-lined by dip-coating the vessel in a bath of low melting glass with low melt viscosity. The glass tank can be heated with an induction heating system. The vessels will be glass-lined on both the sides. This dip-coating method can be used for coating monomeric, oligomeric and polymeric materials of relatively low viscosity further containing thermally activatable catalysts followed by heating the metal objects with induction heating or curing with ionizing radiation.

### Preferred Embodiment of Materials, Apparatus and Processes

In order to get good bonding between the metal and the first coat which is usually ground coat or primer, the surface of the metal must be cleaned and microscopically roughened. The most common metal used for glass lining is steel and steel alloys; usually steel/iron containing less than 5% carbon. Carbon steel gets easily oxidized. The conventional method of removing rust is sanding or sand blasting, dissolving rust with acids and alkali. Commercially available rust remover formulations and process can be used for removing the rust. The surface cleaning materials and procedures reported in EP 0256728 and U.S. Pat. Nos. 4,351,673; 4,424,079; 4,521,253; 5,468,303; 5,653,917 and 6,514,350 can be used for the devices and processes disclosed herein with or without proper modifications to clean the surface of substrates and these patents are incorporated herein by references.

The oxidation of the metal surfaces especially steel surfaces can be minimized by passivating the surface, e.g., by Pickerizing, phosphating, bluing and browning. The rust, iron oxide can be removed by reducing it to iron with reducing agents including exposing to hydrogen or mixture of hydrogen and an inert gas such as nitrogen. Commercially available materials and equipment can be used for cleaning the surface including the apparatus and the fast method of cleaning shown in FIGS. 1 and 2.

The cleaned surface can be coated with a frit (under coat and cover coat) using standard coating methods such as brushing, spray coating, and electrostatic coating.

Once the surface is cleaned, in order to get good bonding, a primer or ground coat should be applied. Formulations and method disclosed in U.S. Pat. Nos. 4,410,598; 5,387,439; 5,387,439; 6,511,931; 6,815,013; 6,815,013; 7,341,964; 8,278,229; 8,278,229; and EP1354978 and US patent application No. 20090270240 and 20110262758 can be used for the formulations, devices, and processes disclosed herein with or without proper modifications to provide a ground coat on a metal objects by induction heating and are incorporated herein by references. The heating and melting of the ground coat can be done with one or more of the apparatus and processes associated with FIGS. 3-15.

Once the ground coat is applied and melted then a frit of glass, ceramic, glass ceramic and an enamel can be applied. A wide variety of formulations of glass, ceramic, glass ceramic and an enamel and methods of making and applying them on a substrate are reported in the literature.

Glass, porcelain, enamel and glass frit, including those without toxic materials such as lead, bismuth and cadmium, resistant to chemicals such as alkali and acid, specialty glasses, such as conductive glasses, nano sized frit, for lining metal objects disclosed in WO 2009097264, EP 0677597, EP 0887322, U.S. Pat. Nos. 4,066,465; 4,224,074; 4,243,421; 4,311,505; 4,359,536; 4,361,654; 4,446,241; 4,537,862; 4,554,258; 4,702,884; 4,731,347; 4,788,163; 4,892,847; 4,975,391; 5,281,560; 5,308,803; 5,350,718; 5,387,439; 5,812,062; 5,900,380; 6,100,209; 6,815,013; 7,736,546; 7,863,207; 8,252,708; 8,278,229; and US Patent applications 20020035025; 20020187889; 20080090034; and 20090189126 can be used for the formulations, devices and processes disclosed herein with or without proper modifications to make glass-lined metal objects by induction heating and are incorporated herein by references.

Most of steel and its alloys have melting temperature higher than ˜1100° C. The lowest temperature at which a plain carbon steel can begin to melt is 1,130° C. Steel never turns into a liquid below this temperature. Pure iron (‘steel’ with 0% Carbon) starts to melt at 1,492° C. and is completely liquid upon reaching 1,539° C. Steel with 2.1% Carbon by weight begins melting at 1,130° C. and is completely molten upon reaching 1,315° C. Except silica glass (which melts at 1580° C.), most of glass, ceramic and glass ceramic melt below 800° C., for example soda-lime glass melts at 700° C., borosilicate glass melts at 820° C. aluminosilicate glass melts at ˜900° C. and leaded glass at ˜630° C. High melting glass lining is required for applications such as utensils, hot water heaters and very high temperature chemical reactors. However, for most of the other applications high temperature glass lining (melting at higher temperatures, e.g., above 300° C.) is not required. It is often practical to replace high melting glass with a low melting glass.

Glasses melting below ˜600° C. are reported and some of them are available commercially. Low melting glass formulations disclosed in EP 0204432; EP 0514639; EP 0551100, EP 1361199; EP 2457477 and U.S. Pat. Nos. 2,492,523; 2,842,458; 2,911,312; 3,383,225; 3,408,212; 3,650,778; 3,927,243; 3,983,060; 4,004,936; 4,186,023; 4,251,595; 4,310,357; 4,312,951; 4,365,021; 4,376,169; 4,417,913; 4,469,798; 4,493,900; 4,590,171; 4,678,358; 4,743,302; 4,748,137; 4,774,208; 4,877,758; 5,116,786; 5,188,990; 5,256,604; 5,281,561; 5,306,674; 5,346,863; 5,534,469; 5,643,840; 5,733,828; 5,902,758; 6,129,854; 6,248,679; 6,291,092; 6,344,424; 6,348,424; 6,355,586; 6,475,605; 6,620,747; 6,652,972; 6,936,556; 7,291,573; 7,923,393; 7,935,279; 8,133,829 and US Patent Application No. 200501531; 20010021444; 20020128141; 20030228471; 20040106018; 20040207314; 20050153142; 20060105898; 20090247385; 20120118168 and 20130090226 can be used for the formulations, devices and processes disclosed herein with or without proper modifications to make glass-lined metal objects by induction heating and are incorporated herein by references.

Glass lining by dip coating of a metal object in a molten glass bath is possible with the above low melting glasses as their viscosity will be low enough at 700-1,000° C. for dipping a metal object without deformation or melting it.

Processes and formulations for glass lining metal objects, such as bath tubes, utensils, reaction vessels, pipes and irregular shaped parts (e.g., stirrer) are disclosed in many patents and patent applications including EP 221,687; EP 677,597; EP 1,585,591, EP 2,050,725 and U.S. Pat. Nos. 3,156,035; 3,235,290; 3,281,226; 3,729,803; 4,311,505; 5,143,275 and 6,815,013 and US Patent applications No. 20120118202 and 20130022428 and in Japan Patent application No. 2010248632 and can be used for the formulations, devices, and processes disclosed herein with or without proper modifications to make glass-lined metal objects by induction heating and are incorporated herein by references.

Japan Patent Application No. 1987000096271 discloses a Teflon® coating on glass. If the metal object is to be coated with plastic, plastic powder including Teflon® and other fluorinated polymers can be applied and melted with induction heating.

One can apply a ground coat, dry and apply a coat of glass frit, dry and then fire. The ground coat frit should have fusion temperatures of ˜30° C. or more below the fusion temperature of the frit employed in the cover coat. Upon gradual heating the ground coat will melt first as metal is heated first in case of the induction heating followed by melting of the glass coat. The present method allows bubbles to migrate on the surface and will provide smooth, defect free coat.

Depending upon the ultimate use, a large number of glass frit formulations reported in the literature can be used for the present inventions. For example, a frit composition composed of 65 to 75 mol % of SiO₂, 2 to 8 mol % of ZrO₂, 10 to 22 mol % of R₂O where R represents Li, K, or Cs, and 2 to 12 mol % of R′O where R′ represents Mg, Ca, Sr, or Ba, and the frit is free of Na₂O and another composition composed of SiO₂ in the range of 65 to 75 mol %, ZrO₂ in the range of 2 to 8 mol %, R₂O in the range of 10 to 22 mol % where R represents Li, K, or Cs, and R′O in the range of 2 to 12 mol % where R′ represents Mg, Ca, Sr, or Ba can be used.

The apparatus and method proposed herein are not only limited to glass, ceramic or glass ceramic. The lining material on the metal parts can be any organic polymer (including nonstick materials such as organo-silicon and halogenated or per fluorinated polymers such as Teflon®), non-conductive, non-metallic, insulating, crystalline, partially or glassy, non-stick and other fusible materials. Even though the apparatus and processes are described for glass lining a metal object such as a steel reaction vessel, it can be used for lining metal objects with plastics such as Teflon®, ceramic, glass ceramics, and enamels.

The conventional method of heating a metal object for glass lining is to heat it inside a electric or gas fired oven. Another method of heating conductive materials such as metal is by induction heating. Induction heating and coils system disclosed in U.S. Pat. Nos. 3,461,215; 4,610,711; 4,780,121; 4,874,916 and 5,237,144 and those available commercially can be used for the formulations, devices and processes disclosed herein with or without proper modifications to make glass-lined metal objects by induction heating and are incorporated herein by references.

Most of the metal objects for glass lining are usually thin, e.g., maximum thickness of about 5 cm. Heating such thin metal with induction heating would not pose any problem, especially with apparatus shown in FIGS. 3-15.

Though an electric furnace is a standard apparatus for heating frit coated metal parts, several specialized apparatus and equipment are proposed for heating the metal objects and melting glass by convection heating. Apparatus disclosed in U.S. Pat. Nos. 4,532,885; 4,538,543; JP 63107837 can be used for the formulations, devices and processes disclosed herein with or without proper modifications to make glass-lined metal objects by induction heating and are incorporated herein by references. Preferred apparatus are those shown in FIGS. 3-15.

Glass-lined metal objects often get damaged and it is economical to repair rather than replace. Several formulations and methods are proposed for repairing damaged glass-lined vessels. Formulations and procedure proposed in EP 407,027; EP 486,323; U.S. Pat. Nos. 4,172,877; 4,508,455; 4,940,607; 5,053,251; 5,143,275; 5,651,827 and US Patent Application No. 20090270240 can be used for the formulations, devices and processes disclosed herein with or without proper modifications to repair damaged glass-lined metal objects by induction heating and are incorporated herein by references.

U.S. Pat. No. 5,053,251 discloses a method of repairing a damaged portion of a glass layer of glass-lined steel equipment by repeated steps of applying a repair agent to a damaged area of the glass layer and then heating the repair agent for solidification and adherence to the glass by the use of a sol-gel process, until a thickness of a repair glass layer becomes almost equal to the existing glass layer adjacent thereto without generating cracks or exfoliations in the glass.

Tatsuo Hara et al in EP0486323 A1 and Journal of the Ceramic Society of Japan; VOL. 101; NO. 1178; PAGE. 1169-1174; (1993) report results on application of the alumina powder composite by sol-gel method to repair a damaged-part of glass lined vessels. The feasibility of the alumina powder composite gel-glass which melts at 300° C. was shown by the standard tests for permeation, adhesion strength, thermal fatigue strength and thermal shock strength, and that the durability against organic solvents was equivalent to that of the lining glass.

A system proposed in FIG. 16 can be used for repairing damaged glass lined vessel, especially on site and even without moving the vessel. The system of FIG. 16 provides a rapid heating of metal by induction heating and that of glass coating by convection heating. Higher temperatures can be achieved for making the glass and applied formulation for repair to have sufficient fluidity. Fine cracks and pinholes can be quickly fixed by this method.

The outer surface of glass lined parts such as stirrers and inside surface of glass lined reactors need to be cleaned as the materials used for synthesis and processing of organic materials including polymers remain on the surface the glass. Hot water, organic solvents or special cleaners are used to clean the surfaces or stuck material is physically removed. It is possible to burn the organic material by heating the glass lined parts and vessel at about 400 to 600° C. with an induction heating system proposed herein. At these temperature most of the organic materials including polymers will be completely burned and a sterilized cleaned surface can be obtained. The soot and other decomposed material can be removed by blowing air.

It is also possible to heat the content of the vessel by induction heating.

The sol-gel process is a wet-chemical technique widely used in the fields of materials science and ceramic engineering. Such methods are used primarily for the fabrication of materials (typically metal oxides) starting from a colloidal solution (sol) that acts as the precursor for an integrated network (or gel) of either discrete particles or network polymers. Typical precursors are metal alkoxides and metal salts (such as chlorides, nitrates and acetates), which undergo various forms of hydrolysis and polycondensation reactions. The materials, methods and applications of sol-gel can be found in (1) Sol-gel processing, Hiromitsu Kozuka ISBN #1-4020-7966-4; (2) Sol-Gel Technologies for Glass Producers and Users, edited by Michael A. Aegerter, M. Mennig, 2004, Springer.

It is known that as the particle size of a material decreases below 1 micron, the melting of the material also decreases. For example, gold behaves like a liquid at room temperature when its particle size is about 1 nanometer (nm). Similarly melting of silica glass can be reduced from 2200° C. to 1200-1300° C. by reducing the particle size to nano scale. Nano and micron sized glasses and ceramics are made by many different methods. One of them is sol-gel method.

U.S. Pat. No. 7,816,292 and U.S. Patent Application #20080044488 disclose methods of making nano to micron size particles of oxides to make glasses which includes SiO₂, B₂O₃, P₂O₅ Na₂O, Li₂O, K₂O, CaO, MgO, SrO, BaO, Al₂O₃, TiO₂, ZrO₂, ZnO, La₂O₃, WO₃, Nb₂O₅, PbO, Ag₂O. By selecting proper oxides and quantity, and melting the mixture, a variety of glasses can be made at lower temperatures. U.S. Patent Application No. 20120138215 discloses a nano glass powder for a sintering additive and a method for fabricating the same. The method for fabricating the nano glass powder for the sintering additive includes fabricating a mixed solution by dissolving a raw material of boron (B), a raw material of silicon (Si), and a raw material of a metal oxide in a non-aqueous solvent; controlling a sol-gel reaction by adding an alkali catalyst to the mixed solution, drying a sol-gel material obtained by the sol-gel reaction, and heat treating the sol-gel material. EP 2386525 application discloses a nanostructured calcium phosphate glass by sol-gel method. Borosilicate glass can be synthesized through sol gel process using tetra-ethyl ortho silicate as silica source, boric acid for B₂O₃, aluminum nitrate for alumina source, sodium nitrate for sodium oxide source, potassium nitrate for potassium oxide source and zinc nitrate for zinc oxide source. Nitric acid can be used as a catalyst and ethanol and distilled water can be used as solvents. The glass materials made by sol-gel method can be used instead of normal frit for making ground and cover coats and for repairing the damaged vessels and parts.

Temperature and other process can be monitoring using the standard analytical equipment.

In addition to the advantages mentioned above, the apparatus and processes of glass lining metal objects by induction heating offer many advantages over the conventional apparatus and processes: The systems are significantly safer, less expensive, faster, easy to operate, any shaped object can be glass lined, require less space than ovens, provide very uniform and defect free coating, little or no deformation of the objects, least or no sagging of the molten glass etc. Vessels can be heated, cleaned, repaired locally without removing from the site.

While the inventions have been described in conjunction with a specific examples thereof, this is illustrative only. Accordingly, many alternatives, modifications and variations will be apparent to those skilled in the art in light of the foregoing descriptions, and it is therefore intended to embrace all such alternatives, modifications and variations as to fall within the spirit and broad scope of the disclosures herein.

1-21. (canceled)

22. A method of making a ceramic, ceramic glass, or glass layered metal object which comprises
a) applying a coat of frit of ceramic, ceramic glass, or glass on a metal object;
b) placing an induction coil around or inside the metal object coated with a frit of the ceramic, ceramic glass or glass;
c) turning the induction coil on; and
d) melting the frit by heating the metal with an induction coil.

23. The method of claim 22 wherein the metal is steel or steel alloy.

24. The method of claim 22 wherein the metal object is a pipe, reaction vessel, utensil or water heater.

25. The method of claim 22 wherein the metal object coated with the frit is fully covered with the induction coil or the induction coil is fully covered with the metal object coated with the frit.

26. The method of claim 22 wherein the metal object coated with the frit is partially covered with the induction coil and the frit is melted by either (i) moving either the coil or the metal object while keeping the other stationary, (ii) rotating the metal object, or (iii) moving the induction coil inside or outside the metal object.

27. The method of claim 22 wherein one induction coil is inside the metal object coated with the frit and another induction coil is outside the metal object coated with the frit.

28. The method of claim 22 wherein the frit is melted with convection heat generated by another metal object heated with induction heating.

29. The method of claim 22 wherein the frit is a low melting ceramic, glass ceramic or glass.

30. A process of repairing a glass layered metal object comprising
a) applying a coat of ceramic, ceramic glass or glass powder to a metal object on the damaged portion of the metal object;
b) melting the powder either (i) by convection heat generated by induction heating of the metal object or (ii) with convection heat generated by another metal object heated with induction heating.

31. A process of cleaning a glass layered metal object by heating the object with induction heating.

32. A method of making a ceramic, ceramic glass, or glass layered metal object which comprises
a) introducing molten glass or melting glass on the inside surface of the metal object heated with an induction coil; and
b) coating the metal surface with the molten glass with a squeegee.

33. An apparatus for making a ceramic, ceramic glass, or glass layer on a metal object comprising a metal object coated with a frit of ceramic, ceramic glass or glass, an induction coil for heating the metal object by induction heating the metal and a means to move the metal object or the induction coil.

34. An apparatus of claim 33 wherein (i) the metal is partially or fully covered with the induction coil or (ii) the induction coil is fully or partially covered with a metal object and a means to move the metal object or the induction coil.
